(19) United States
(12) Patent Application Publication
(10) Pub. No.: US 2015/0379112 A1
(43) Pub. Date: Dec. 31, 2015

(54) CREATING AN ON-LINE JOB FUNCTION ONTOLOGY

(71) Applicant: LinkedIn Corporation, Mountain View, CA (US)

(72) Inventors: Gloria Lau, Los Altos, CA (US); Vitaly Gordon, Mountain View, CA (US); Kin Fai Kan, Sunnyvale, CA (US)

(21) Appl. No.: 14/318,496

(22) Filed: Jun. 27, 2014

(51) Int. Cl. G06F 17/30

(52) U.S. Cl. CPC G06F 17/30598

(57) ABSTRACT

Method and system to create a job function ontology may be utilized to derive, from member profiles maintained in an on-line social networking system, job function entities associated with respective sets of professional attributes. An entry in the job function ontology—a job function entity—may include identification of the associated job function, as well as a set of professional attributes that characterize professional skills of a member of the on-line social network system. A label assigned to a job function entity may be viewed as a standardized job title.

### TECHNICAL FIELD

This application relates to the technical fields of software and/or hardware technology and, in one example embodiment, to system and method to create a job function ontology in an on-line social network system.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be represented by one or more web pages, or a structured representation of the member's information in XML (Extensible Markup Language), JSON (JavaScript Object Notation) or similar format. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to create a job function ontology may be implemented;

FIG. 2 is block diagram of a system to create a job function ontology, in accordance with one example embodiment;

FIG. 3 is a flow chart of a method to create a job function ontology, in accordance with an example embodiment; and

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to create job function ontology in an on-line social network is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method describe herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). A member profile may be associated with social links that indicate the member's connection to other members of the social network. A member profile may also include or be associated with comments or recommendations from other members of the on-line social network, with links to other network resources, such as, e.g., publications, etc. As mentioned above, an on-line social networking system may be designed to allow registered members to establish and document networks of people they know and trust professionally. Any two members of a social network may indicate their mutual willingness to be “connected” in the context of the social network, in that they can view each other's profiles, profile recommendations and endorsements for each other and otherwise be in touch via the social network.

The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills. Information about a member's professional skills may be referred to as professional attributes. Professional attributes may be maintained in the on-line social network system and may be used in the member profiles to describe and/or highlight professional background of a member. Some examples of professional attributes (also referred to as merely attributes, for the purposes of this description) are strings representing professional skills that may be possessed by a member (e.g., “product management,” “patent prosecution,” “image processing,” etc.). Thus, a member profile may indicate that the member represented by the profile is holding himself out as possessing certain skills. A member profile may also indicate that one or more skills of the member have been endorsed by other members of the on-line social networking system. The information in a member profile indicating that certain skills have been endorsed by one or more other members, may be termed endorsed skills or endorsements. Endorsements may be with respect to skills that are included in the member profile, and also with respect to skills that are not included in the member profile. Both skills and endorsements may be considered to be professional attributes, for the purposes of this description. In some embodiments various other aspects of a member profile, such as, e.g., data indicative of a member's behavior in the on-line social network system, job transition information, etc., may be utilized as professional attributes by the system to create job function ontology.

The profile of a member may also include information about the member's current and past employment, such as company identifications and professional titles. Professional titles that appear in member profiles are not always descriptive enough to permit a clear assessment of the respective member's professional skill set, which may make it difficult to correctly ascertain whether a certain job posting would be appropriate for presentation to a particular member of the on-line social networking system. For example, similar positions at different companies may have titles such as “software engineer,” “developer,” “programmer,” etc. Some job positions, while identified by different labels may require similar or greatly overlapping professional skills. Conversely, some positions may have identical labels, but require entirely different skill sets, depending on the associate industry and company (e.g., a job title “vice president” does not, on its own, provide sufficient information about the job holder's professional experience).

In one example embodiment, method and system to create a job function ontology may be utilized beneficially to derive, from member profiles maintained in an on-line social networking system, job function entities associated with respective sets of professional attributes. A system for creating a job function ontology may be referred to as a title standardization system. An entry in the job function ontology—a job function entity—may include identification (or a label) of the associated job function, as well as a set of professional attributes that characterize professional skills of a member of the on-line social network system. A label assigned to a job function entity may be viewed as a standardized job title. For example, a job function that requires a certain set of software development skills may be represented by the “programmer” label. A label may also be any alpha-numeric string. Some example job functions are business analyst, sales, human resources, and IT technicians.

A member profile may be associated with a certain job function based on the professional attributes that are found in the member profile, e.g., based on skills and endorsements associated with the member profile. Thus, two member profiles that have different job titles (e.g., “computer analyst” and “senior architect”) may be associated with the same job function and, subsequently, presented with the same job listings, if the skills and endorsements present in these two profiles are substantially similar.

In one example embodiment, a title standardization system first selects certain companies for which to examine professional titles present in the associated profiles. From member profiles associated with a particular company (e.g., for profiles that include an identification of the particular company in the employment section of the profiles) the title standardization system derives so called title entities by selecting all profiles associated with the particular company and a particular job title in that company and representing these profiles by a single record, a title entity. Thus created title entity comprises a title string representing the particular job title and those professional attributes that occur most commonly in these profiles. Professional attributes that occur most frequently within a group of profiles associated with the same job title in the same company may be considered as representative of that position in that company. In one embodiment, the title standardization system may also group title entities that have a certain number or a certain percentage of overlapping skills. Professional attributes that are extracted from the profiles to be potentially included in a title entity may be filtered, automatically, to exclude those professional attributes that are not necessarily representative of the position with that particular title within the company, e.g., those professional attributes that are rare across all member profiles. For each title entity, only those professional attributes are retained that occur frequently with that title entity but not so frequently across all member profiles.

The sets of title entities may be created for all companies referenced in the profiles in the on-line social network system or for just some select companies that may be selected according to a predetermined criteria, such as the size of a company. The title entities created for various companies, together, may be referred to as a combined set of title entities.

The combined set of title entities may be examined to derive job function entities. White a title entity is associated with a particular title string and represents most frequently occurring skills associated with that job title in a particular company, a job function entity is defined by a set of skills irrespective of the exact title that may be associated with that set of skills or any company listed in profiles that include same or similar skills. The process for deriving job entities from a combined set of title entities may entail comparing respective attribute sets of title entities in pairs of title entities and clustering similar title entities together, irrespective of their title strings and respective associated company identifications. Similarity between two title entities may be determined by comparing their respective sets of attributes. Title entities that include a certain number or percentage of overlapping attributes may be clustered together. A job function entity may be derived from a cluster of title entities by selecting all or a certain portion of attributes that occur most frequently in the title entities of the cluster and associating it with an identification of a job function entity.

In one embodiment, the clustering of title entities from the combined set of title entities may be a so-called hierarchical clustering, where a job function entity may have a parent-child relationship with one or more other job function entities. For example, a job function entity associated with professional attributes representing various computer engineering skills may be defined as a parent with respect to a job function entity representing skills associated with software engineers and also with respect to a job function entity representing skills associated with hardware engineers.

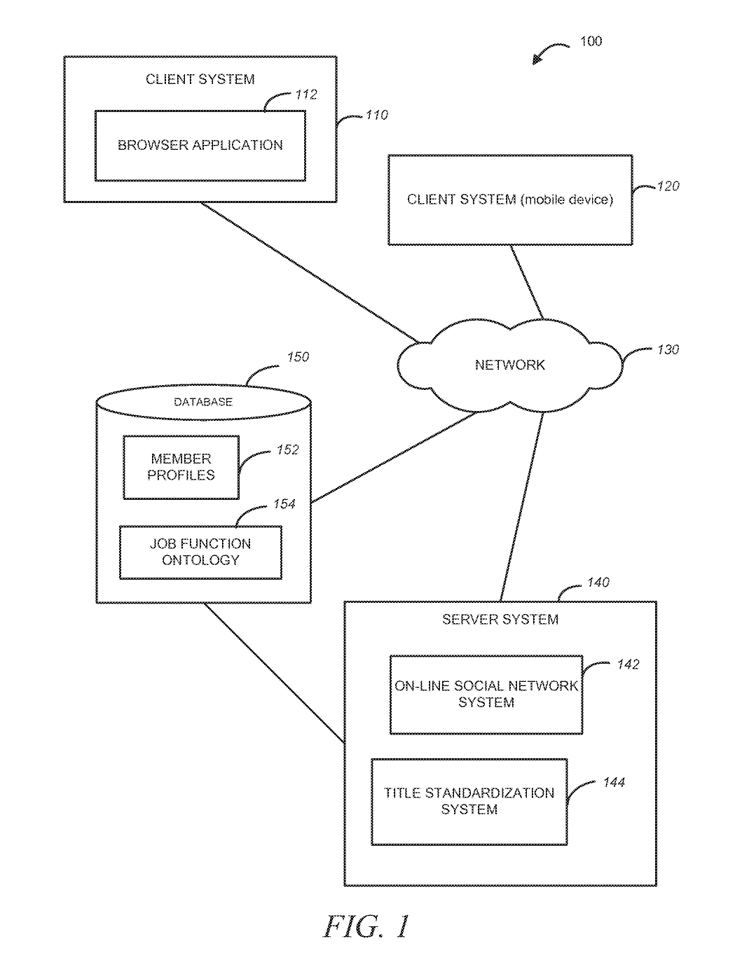

Thus derived plurality of job function entities may be referred to as a job function ontology. The job function entities in the job function ontology may be periodically updates so that the job function ontology reflects changes in the universe of member profiles in the on-line social network system. An example title standardization system may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a title standardization system 144. The title standardization system 144 may be configured to derive, from member profiles 152 maintained in the on-line social networking system 142, job function entities associated with respective sets of professional attributes. The title standardization system 144 may be configured to first determine which skills are typically associated with various positions in a given company. To make this determination, in one example embodiment, the title standardization system 144 first clusters together member profiles associated with the same company identification, creating so-called company-based clusters (or merely clusters). The profiles from the same cluster are further separated into groups, based on a title string that is present in respective profiles. A title string, which may be provided in a section of a member profile that is dedicated to employment information, indicates the title of a position held by the associated member in a given company. From the profiles that were placed in a group associated with the same title string and the same company identification, the title standardization system 144 extracts professional attributes and selects at least a subset of the extracted attributes as representative of the professional skills associated with the position identified by that title string in that company. As explained above, the combination of a title string and a set of attributes that represent professional skills associated with a position identified by a particular title string in a particular company may be termed a title entity. In some embodiments, the title standardization system 144 may combine two or more title entities into a single title entity if, e.g., these entities have similar sets of attributes.

The title standardization system 144 may next examine all title entities derived from all company-based clusters by performing pair-wise comparison to identify title entities that may have different title strings but sufficiently similar respective sets of attributes. In one embodiment, the title standardization system 144 may utilize a similarity metric that, given two entities, determines how similar they are, based on the presence of various professional attributes in the two entities. This model may be configured to return a value between zero and one. For example, when comparing an entity associated with a title string “software engineer” and an entity associated with a title string “senior software engineer,” the model may return a value that is close to one, comparing an entity associated with a title string “structural engineer” and an entity associated with a title string “registered nurse,” the model may return a value that is close to zero. The title standardization system 144 may determine groups of title entities that have sufficiently similar respective sets of attributes and create respective job function entities. A job function entity may be not tied to any particular company identification or any particular title string that may appear in a member profile. A collection of job function entities, which may be organized in a hierarchy, may be termed job function ontology. Thus generated job function ontology may be stored in the database 150 as job function ontology 154. The title standardization system 144 may periodically update the job function ontology 154 and its job function entities.

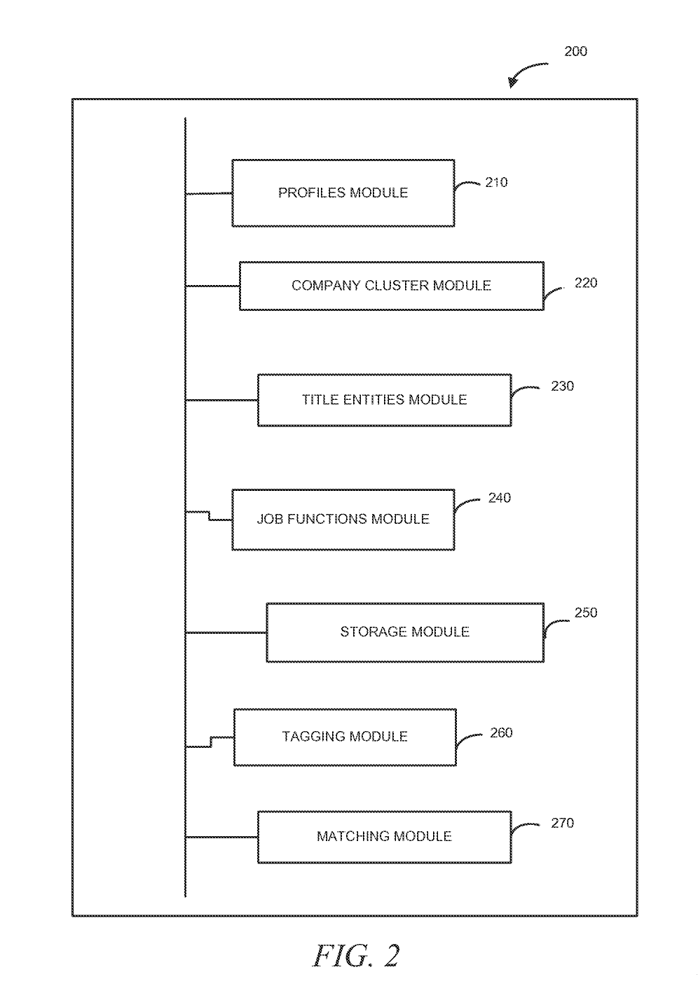

The title standardization system 144 may associate profiles in the on-line social network system with respective appropriate job function entities, based on which professional attributes could be found in a given profile. An identification of a job function associated with a profile may be used to match that profile with various job postings in the on-line social network 142. An example title standardization system 144 is illustrated in FIG. 2.

FIG. 2 is a block diagram of a system 200 to infer seniority level of a social network member, in accordance with one example embodiment. As shown in FIG. 2, the system 200 includes a profiles module 210, a company cluster module 220, a title entities module 230, a job functions module 240, a storage module 250, a tagging module 260, and a matching module 270. The profiles module 210 may be configured to maintain member profiles representing respective members of an on-line social network system, and to maintain professional attributes for describing one or more of the member profiles. The company cluster module 220 may be configured to determine a plurality of profile clusters, each profile from a cluster from the plurality of profile clusters associated with a respective company identification. The title entities module 230 may be configured to determine a set of title entities for each cluster from the profile clusters. Specifically, the title entities module 230 may be configured to select, from a cluster from the profile clusters, profiles that include a particular title string representing a job position in a company, extract, form the profiles that include the particular title string, professional attributes, and associate one or more of the extracted professional attributes with the particular title string, thus creating a title entity. The title entities from all of the profile clusters may be termed a combined set. The job functions module 240 may be configured to derive a plurality of job function entities from the combined set. A job function entity from the set of job function entities includes a set of attributes from the professional attributes. Specifically, the job functions module 240 may be configured to group one or more title entities from the combined set into a group of similar title entities, e.g., based on results of pair-wise comparison of title entities from the combined set, where the title entities from the group include a certain percentage of overlapping professional attributes, and create a job function entity from the plurality of job function entities. A job function entity is associated with at least a subset of attributes from professional attributes present in title entities from the group of similar title entities. The job functions module 240 may also be configured to organize the plurality of job function entities as a hierarchy of job function entities.

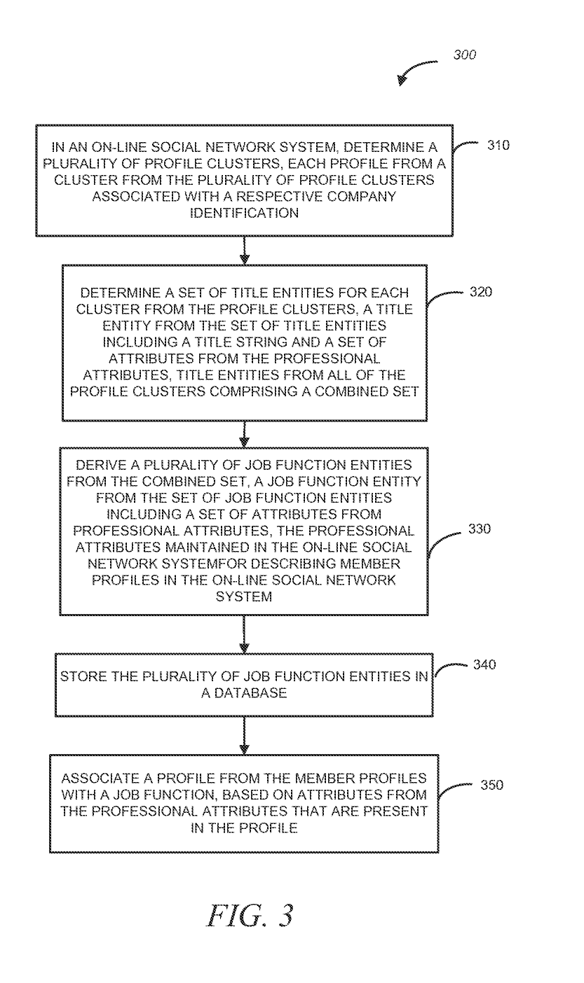

The storage module 250 may be configured to store the plurality of job function entities in a database. The tagging module 260 may be configured to associate a profile from the member profiles with a job function, based on attributes from the professional attributes that are present in the profile. The matching module 270 may be configured to access a job posting in the on-line social network system and, based on a job function associated with a profile from the member profiles, select the profile for presentation with the job posing. Some operations performed by the system 200 may be described with reference to FIG. 3.

FIG. 3 is a flow chart of a method 300 to infer seniority level of a social network member, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the company cluster module 220 of FIG. 2 determines a plurality of profile clusters, each profile from a cluster from the plurality of profile clusters associated with a respective company identification. At operation 320, the title entities module 230 of FIG. 2 determines a set of title entities for each cluster from the profile clusters. At operation 330 the job functions module 240 of FIG. 2 derives a plurality of job function entities from the combined set. At operation 340, the storage module 250 of FIG. 2 stores the plurality of job function entities in a database. The tagging module 260 of FIG. 2 associates a profile from the member profiles with a job function, based on attributes from the professional attributes that are present in the profile, at operation 350.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

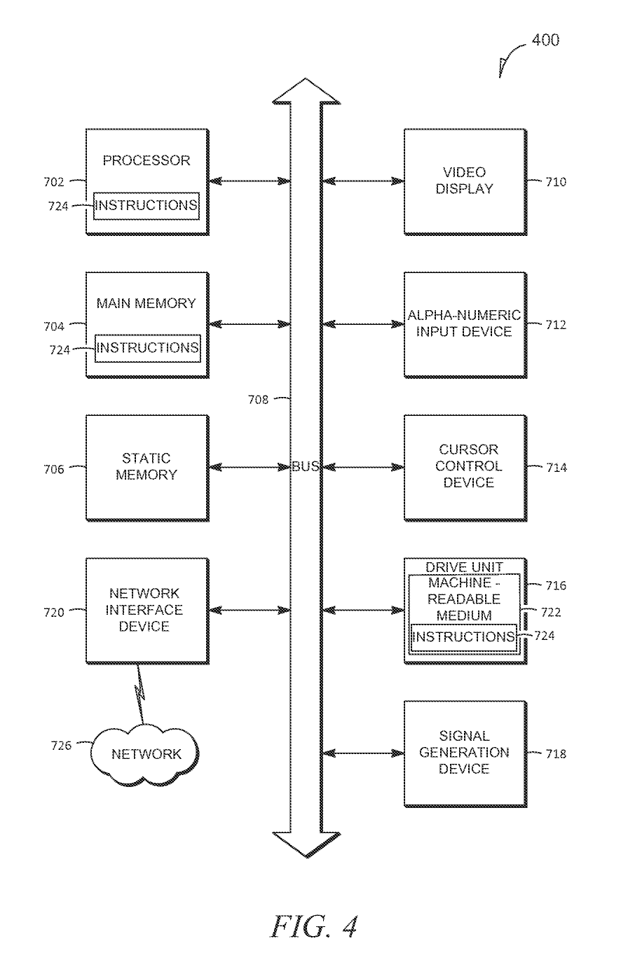

FIG. 4 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perthrm any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations, it will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hard ware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a method and system to create job function ontology has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
in an on-line social network system, maintaining member profiles representing respective members of the on-line social network system, each member profile from the member profiles represented by a respective profile web page that displays one or more professional skills of an associated member, the one or more professional skills of the associated member stored in the on-line social network system as the associated member's professional attributes from an entire set of professional attributes maintained by the on-line social network system;
deriving a plurality of job function entities, using one or more processors, a job function entity from the set of job function entities including a set of attributes from the entire set of professional attributes maintained by the on-line social network system;
associating a selected profile from the member profiles with the job function entity, based on professional attributes that are present in the profile, the professional attributes being from the entire set of professional attributes;
accessing a selected job posting from a plurality of job postings maintained in the on-line social network system; and
causing presentation of the selected job posting to a member represented by the selected profile, based on the job function entity associated with the selected profile.

2. The method of claim 1, wherein the deriving of the plurality of job function entities comprises:
determining a plurality of profile clusters, each profile from a cluster from the plurality of profile clusters associated with the same company identification;
for each cluster from the profile clusters, determining a set of title entities, a title entity from the set of title entities including a title string and a set of attributes from the professional attributes, title entities from all of the profile clusters comprising a combined set; and
deriving the plurality of job function entities from the combined set.

3. The method of claim 1, comprising:
storing the plurality of job function entities in a database.

4. The method of claim 2, wherein the deriving of the plurality of job function entities comprises:
grouping one or more title entities from the combined set into a group of similar title entities, the title entities from the group comprising a certain percentage of overlapping professional attributes; and
creating a job function entity from the plurality of job function entities, the job function entity associated with at least a subset of attributes from professional attributes present in title entities from the group of similar title entities.

5. The method of claim 4, wherein the grouping of the one or more title entities from the combined set into the group of similar title entities is based on results of pair-wise comparison of title entities from the combined set.

6. The method of claim 1, comprising organizing the of job function as a hierarchy of job function entities.

7. The method of claim 2, wherein the company identification is from a plurality of company identifications, the method comprising selecting company identifications to be included in the plurality of company identifications.

8. The method of claim 7, wherein the selecting of company identifications is utilizing company size values associated with the respective company identifications.

9. The method of claim 2, wherein the creating a title entity from the set of title entities comprises:
selecting, from a cluster from the profile clusters, profiles that include a particular title string, the particular title string representing a job position in a company represented by a company identification associated with the cluster;
extracting, form the profiles that include the particular title string, professional attributes; and
associating one or more of the extracted professional attributes with the particular title string.

10. The method of claim 1, comprising updating, periodically, the plurality of job function entities.

11. A computer-implemented system comprising:
a profiles module, implemented using one or more processors, to maintain member profiles representing respective members of an on-line social network system, each member profile from the member profiles represented by a respective profile web page that displays one or more professional skills of an associated member, the one or more professional skills of the associated member stored in the on-line social network system as the associated member's professional attributes from an entire set of professional attributes maintained by the on-line social network system;
a job functions module, implemented using one or more processors, to derive a plurality of job function entities, a job function entity from the set of job function entities including a set of attributes from the professional attributes;
a tagging module, implemented using one or more processors, to associate a profile from the member profiles with a job function, based on attributes from the professional attributes that are present in the profile; and
a matching module, implemented using one or more processors, to:
access a selected job posting from a plurality of job postings maintained in the on-line social network system; and
cause presentation of the selected job posting to a member represented by the selected profile, based on the job function entity associated with the selected profile.

12. The system of claim 11, comprising:
a company cluster module, implemented using one or more processors, to determine a plurality of profile clusters, each profile from a cluster from the plurality of profile clusters associated with a respective company identification;
a title entities module, implemented using one or more processors, to determine a set of title entities for each cluster from the profile clusters, a title entity from the set of title entities including a title string and a set of attributes from the professional attributes, title entities from all of the profile clusters comprising a combined set, the job functions module to derive a plurality of job function entities from the combined set.

13. The system of claim 11, comprising
a storage module, implemented using one or more processors, to store the plurality of job function entities in a database.

14. The system of claim 12, wherein the job functions module is to:
group one or more title entities from the combined set into a group of similar title entities, the title entities from the group comprising a certain percentage of overlapping professional attributes; and
create a job function entity from the plurality of job function entities, the job function entity associated with at least a subset of attributes from professional attributes present in title entities from the group of similar title entities.

15. The system of claim 14, wherein the job functions module is to group the one or more title entities from the combined set into the group of similar title entities, based on results of pair-wise comparison of title entities from the combined set.

16. The system of claim 11, wherein the job functions module is to organize the plurality of job function entities as a hierarchy of job function entities.

17. The system of claim 12, wherein the company identification is from a plurality of company identifications, the company cluster module to select company identifications to be included in the plurality of company identifications.

18. The system of claim 17, the company cluster module is to select company identifications, utilizing company size values associated with the respective company identifications.

19. The system of claim 12, wherein the title entities module is to:
select, from a cluster from the profile clusters, profiles that include a particular title string, the particular title string representing a job position in a company represented by a company identification associated with the cluster;
extract, form the profiles that include the particular title string, professional attributes; and
associate one or more of the extracted professional attributes with the particular title string.

20. A machine-readable non-transitory storage medium having instruction data to cause a machine to perform operations comprising:
maintaining member profiles representing respective members of an on-line social network system each member profile from the member profiles represented by a respective profile web page that displays one or more professional skills of an associated member, the one or more professional skills of the associated member stored in the on-line social network system as the associated member's professional attributes from an entire set of professional attributes maintained by the on-line social network system;
deriving a plurality of job function entities, a job function entity from the set of job function entities including a set of attributes from the entire set of professional attributes maintained by the on-line social network system;
associating a selected profile from the member profiles with the job function entity, based on professional attributes that are present in the profile professional attributes being from the entire set of professional attributes;
accessing a selected job posting from a plurality of job postings maintained in the on-line social network system; and
causing presentation of the selected job posting to a member represented by the selected profile, based on the job function entity associated with the selected profile.
